(19) United States
(12) Patent Application Publication
(10) Pub. No.: US 2023/0320393 A1
(43) Pub. Date: Oct. 12, 2023

(54) METHOD AND DEVICE FOR MANUFACTURING TOFU PRODUCTS

(71) Applicant: TAKAI TOFU & SOYMILK EQUIPMENT CO., Ishikawa (JP)

(72) Inventors: Toichiro TAKAI, Ishikawa (JP); Yusuke SETO, Ishikawa (JP)

(73) Assignee: TAKAI TOFU & SOYMILK EQUIPMENT CO., Ishikawa (JP)

(21) Appl. No.: 18/044,198

(22) PCT Filed: Aug. 25, 2021
(86) PCT No.: PCT/JP2021/031255

§ 371 Date: Mar. 6, 2023

(30) Foreign Application Priority Data
Sep. 7, 2020 (JP) 2020-149764

(51) Int. Cl. A23L 11/45; B08B 9/093; B01F 35/10; B01F 27/112

(52) U.S. Cl. CPC A23L 11/45; B08B 9/093; B01F 35/1452; B01F 27/112; B08B 2203/007; B08B 2209/08; B01F 2101/06

(57) ABSTRACT

A method for producing tofu products includes: discharging a coagulated product in which soymilk and a coagulant are mixed with each other using a coagulation device, the coagulation device including a coagulation bucket and a water spray device inside the coagulation bucket. The discharging the coagulated product includes: spraying water from the water spray device to wash away an adhered coagulated product in which the soymilk and the coagulant are mixed with each other and which is adhered to an inside of the coagulation bucket; and mixing a dispersion liquid of the adhered coagulated product with the coagulated product for use.

### TECHNICAL FIELD

The present invention relates to a method and an apparatus for producing tofu products by using a coagulation device.

### BACKGROUND ART

In related art, as an example of a tofu production method for producing tofu products by coagulating soymilk, as shown in FIG. 11, a coagulation device 10 and a forming device 3 are separately provided, soymilk supplied from a soymilk plant 1 is coagulated in a coagulation bucket 11 of the coagulation device 10 by a coagulant supplied from a coagulant tank 2 to obtain a soymilk coagulated product, the soymilk coagulated product is then sent to the forming device 3, and tofu products are obtained by pressing and forming. After the forming, the tofu products are cut into a predetermined size, and then transferred to a subsequent step such as being stored in packs, being fried by a fryer 4, or being frozen in a freezer 5.

In Patent Literature 1, a tofu production method for producing silken tofu or the like in a large amount has been known in which detachability of the tofu from storage portions of a plurality of coagulation buckets provided side by side on a conveyor is improved by spraying water from fluid spray nozzles toward the storage portions. Patent Literature 2 describes that hot water is sprayed from a lid of a coagulation container or an upper side of a side wall of the coagulation container into the coagulation container to clean an inside of the coagulation container.

### CITATION LIST

### Patent Literature

Patent Literature 1: JP2018-174836A

Patent Literature 2: JP2014-132902A

### SUMMARY OF INVENTION

### Technical Problem

Incidentally, in the coagulation bucket 11 of the coagulation device 10, a coagulation step is repeated, so that an adhered coagulated product is stacked and grown on a container wall, a stirring blade, and the like a stalactite or a Baumkuchen. When the coagulation step is performed in a state where such an adhered coagulated product remains in the coagulation bucket 11, a stirring state of the soymilk changes or a coagulation state of the soymilk (a size or the like of coagulated particles) slightly changes, so that quality of a product (for, example, deep-fried tofu or hard tofu) may be affected, and in some cases, a mass of the adhered coagulated product may also be mistaken as a foreign matter mixed into the coagulation bucket 11. Therefore, in the related art, it is necessary to perform an operation to periodically scrape off the adhered coagulated product in the coagulation bucket 11 by a person.

In the tofu production method described in Patent Literature 1, cleaning of the storage portions of the coagulation buckets each including no liquid discharge port for the silken tofu is mainly described, but cleaning of a coagulation bucket including a liquid discharge port for deep-fried tofu or hard cotton tofu as in the present invention is not mentioned.

In a tofu production method described in Patent Literature 2, it is described that a coagulated product adhered to an inside of the container is washed away by washing with water, but a method for sending a coagulated product dispersion liquid to a next step to use the dispersion liquid is not described.

The present invention has been made in view of the above problems, and an object of the present invention is to provide a method and an apparatus for producing tofu products, which can effectively clean and remove an adhered coagulated product in a coagulation bucket.

### Solution to Problem

The above object of the present invention is achieved by the following configurations.
(1) A method for producing tofu products,
in which in a step of discharging a coagulated product in which soymilk and a coagulant are mixed with each other using a coagulation device comprising a water spray device inside a coagulation bucket (for example, the step includes after discharging the coagulated product or the middle of discharging the coagulated product in the present embodiment), water is sprayed from the water spray device to wash away an adhered coagulated product in which the soymilk and the coagulant are mixed with each other and which is adhered to (remaining in) an inside of the coagulation bucket, and a dispersion liquid of the adhered coagulated product is mixed with the coagulated product for use.
(2) The method for producing tofu products according to (1),
in which the water spray device is configured to spray the water at a constant flow rate.
(3) The method for producing tofu products according to (1) or (2),
in which the water spray device is configured to spray the water during conveyance of the coagulated product, in which the soymilk and the coagulant are mixed with each other, to a next step.
(4) The method for producing tofu products according to any one of (1) to (3),
in which the water sprayed from the water spray device is water for food production, the water being hot water of 40° C. to 100° C. heated by a cleaning water supply device.
(5) The method for producing tofu products according to any one of (1) to (4),
in which the coagulation bucket includes a thermal insulation unit.
(6) The method for producing tofu products according to any one of (1) to (5),
in which the inside of the coagulation bucket is formed of a member subjected to surface polishing or surface treatment processing.
(7) The method for producing tofu products according to any one of (1) to (6),
in which the dispersion liquid of the adhered coagulated product is mixed with the coagulated product in a storage tank for use.
(8) An apparatus for producing tofu products, the apparatus including:
a coagulation device that includes a water spray device inside a coagulation bucket,
in which the water spray device is configured to spray water to wash away an adhered coagulated product in which soymilk and a coagulant are mixed with each other and which is adhered to an inside of the coagulation bucket to mix a dispersion liquid of the adhered coagulated product with a coagulated product for use.
(9) The apparatus for producing tofu products according to (8),
in which the water spray device includes equipment configured to spray water onto the adhered coagulated product at a constant flow rate.
(10) The apparatus for producing tofu products according to (8) or (9),
in which the water spray device is configured to spray the water during conveyance of the coagulated product, in which the soymilk and the coagulant are mixed with each other, to a next step.
(11) The apparatus for producing tofu products according to any one of (8) to (10),
in which the water sprayed from the water spray device is water for food production, the water being hot water of 40° C. to 100° C. heated by a cleaning water supply device.
(12) The apparatus for producing tofu products according to any one of (8) to (11),
in which the coagulation bucket includes a thermal insulation unit.
(13) The apparatus for producing tofu products according to any one of (8) to (12),
in which the inside of the coagulation bucket is formed of a member subjected to surface polishing or surface treatment processing.
(14) The apparatus for producing tofu products according to any one of (8) to (13),
in which a storage tank configured to allow therein the dispersion liquid of the adhered coagulated product to be mixed with the coagulated product is provided in a coagulated product discharge pipe connected to the coagulation bucket.

### Advantageous Effects of Invention

According to the present invention, by spraying water from a water spray device, an adhered coagulated product in a coagulation bucket can be effectively cleaned and removed, and growth of the adhered coagulated product in the coagulation bucket can be prevented. Since a dispersion liquid of the adhered coagulated product is mixed with a coagulated product for use, a yield rate, a yield, and quality of tofu products can be improved.

### BRIEF DESCRIPTION OF DRAWINGS

FIG. 1 is a side view schematically showing a coagulation device in which a method for producing tofu products according to the present invention is applied.

FIG. 2 illustrates (a) which is a side view schematically showing a coagulation bucket, and (b) which is a top view schematically showing the coagulation bucket in (a) with a lid removed.

FIG. 3 is a flowchart showing a coagulation step.

FIG. 4 illustrates (a) which is a view illustrating a cleaning process when a small coagulated product is produced, and (b) which is a view illustrating a cleaning process when a large coagulated product is produced.

FIG. 5 is a view showing an example in which cleaning is performed in the middle of discharging the coagulated product according to a first modification.

FIG. 6 is a view showing another example in which cleaning is performed in the middle of discharging the coagulated product according to a second modification.

FIG. 7 is a view showing still another example in which cleaning is performed in the middle of discharging the coagulated product according to a third modification.

FIG. 8 is a view showing an example in which a dispersion liquid of an adhered coagulated product is mixed with the coagulated product according to a fourth modification.

FIG. 9 is a side view schematically showing the coagulation bucket according to a fifth modification, and (b) is a top view schematically showing the coagulation bucket in (a) with the lid removed.

FIG. 10 is a side view schematically showing the coagulation bucket according to a sixth modification, and (b) is a top view schematically showing the coagulation bucket in (a) with the lid removed.

FIG. 11 is a schematic diagram showing a general tofu production apparatus.

### DESCRIPTION OF EMBODIMENTS

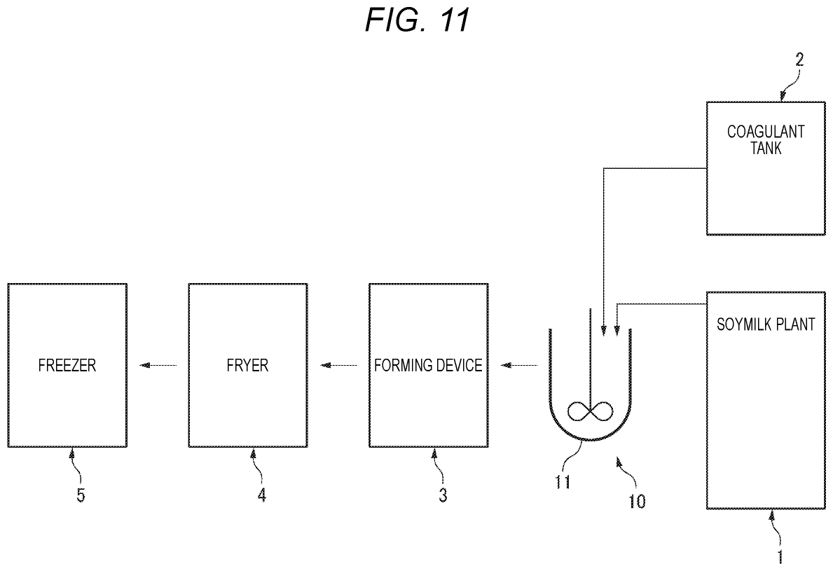

Hereinafter, an example of a method for producing tofu products according to the present invention will be described in detail with reference to drawings. Since the present invention is obtained by improving a configuration of a coagulation device in a tofu production apparatus shown in FIG. 11 and a step in the coagulation device, a coagulation device will be mainly described.

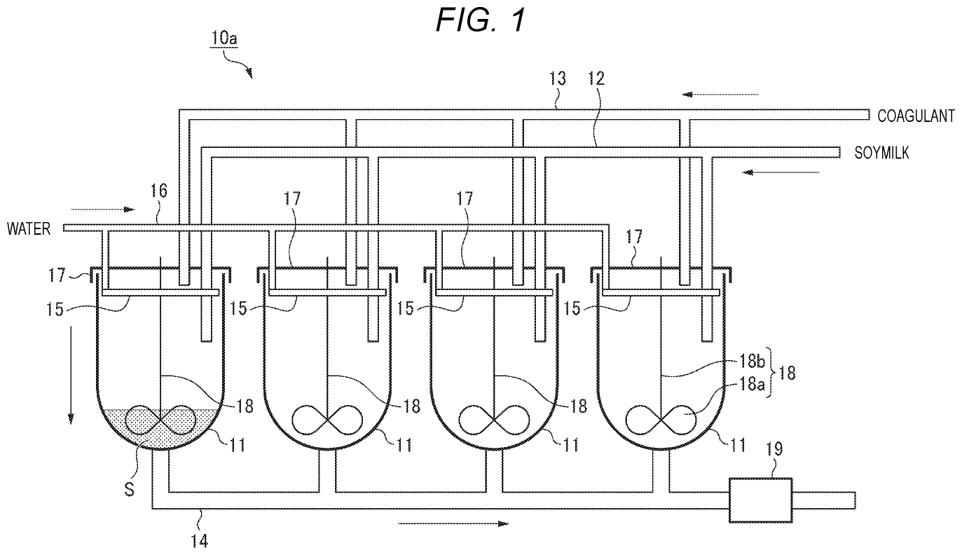

As shown in FIG. 1, in a coagulation device 10a, in a plurality of coagulation buckets 11, there are provided a soymilk supply pipe 12 through which soymilk is supplied from a soymilk plant; a coagulant supply pipe 13 through which a coagulant is supplied from a coagulant tank; a coagulated product discharge pipe 14 through which a coagulated product is discharged; and a cleaning water supply pipe 16 through which cleaning water is supplied from a cleaning water supply device (not shown) toward water spray devices 15.

In the coagulation device 10a, the plurality of coagulation buckets 11 are fixed to a base (not shown) in a vertical posture, and the soymilk supplied from the soymilk supply pipe 12 and the coagulant supplied from the coagulant supply pipe 13 are mixed in each of the coagulation buckets 11, so that a coagulated product S is produced. The coagulated product S is discharged, through the coagulated product discharge pipe 14 connected to a lower portion of the coagulation bucket 11, to a forming step that is a subsequent step.

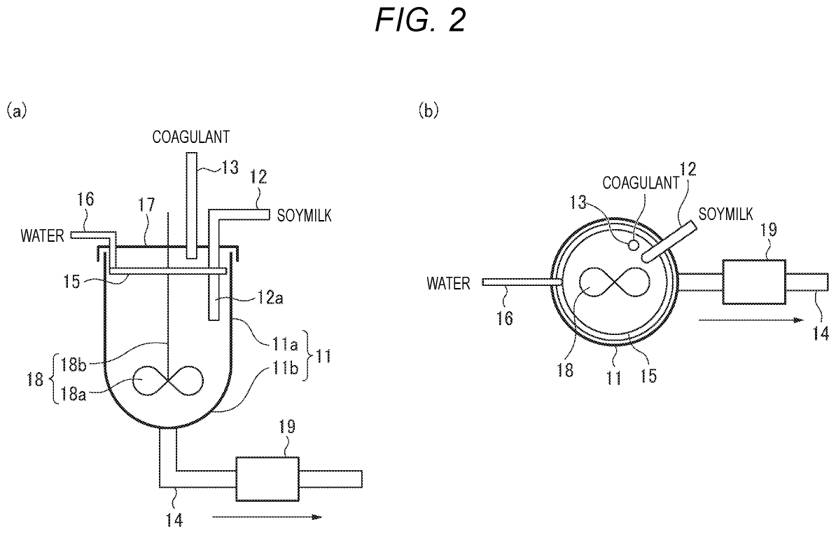

As shown in FIG. 2, the coagulation bucket 11 has a shape in which an upper cylindrical portion 11a and a lower hemispherical bottom portion 11b are continuous with each other, and an openable and closable lid 17 is attached to an upper opening, so that the coagulation bucket 11 can be formed as a substantially sealed structure.

A stirring device 18, which stirs the soymilk and the coagulant and breaks the coagulated product S, is provided in the coagulation bucket 11. The stirring device 18 includes a stirring shaft 18b to which a stirring blade 18a is attached, and the stirring shaft 18b penetrates the lid 17 and is driven by a drive motor (not shown) connected above. The stirring device 18 may be configured to be also drivable in a vertical direction.

Further, the water spray device 15 connected to the cleaning water supply pipe 16 is provided in an upper portion in the coagulation bucket 11. The water spray device 15 includes a ring-shaped water spray pipe disposed along an inner peripheral surface of an upper portion of the cylindrical portion 11a of the coagulation bucket 11, and can clean both a liquid contact portion in the coagulation bucket 11 with which the soymilk, the coagulant, and the coagulated product S come into contact, and splashes adhered to a liquid non-contact portion other than the liquid contact portion. In particular, since the lid 17 is provided, not only a lower portion of the water spray pipe but also an upper portion of the water spray pipe can be washed with water, and when a spray ball nozzle or the like (see a later description) is provided as necessary, an effect of washing with water can be further improved.

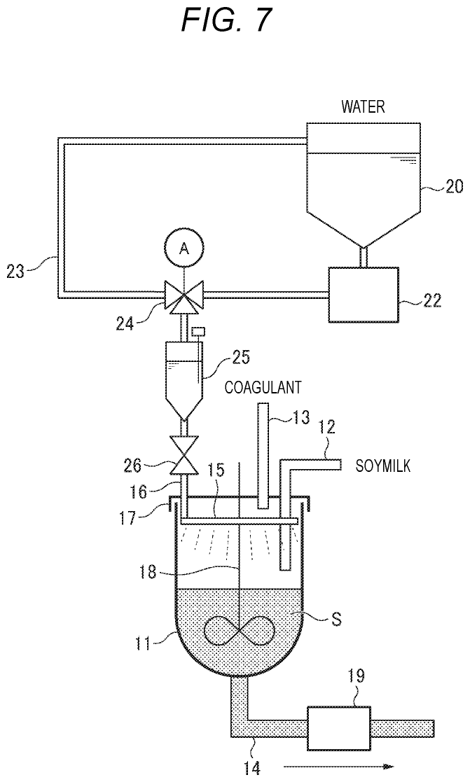

The liquid non-contact portion means inner surfaces of an upper inner wall and the lid 17 of the coagulation bucket 11, and the liquid contact portion includes an inner wall of the coagulation bucket 11, the stirring blade 18a, the stirring shaft 18b, a soymilk feed port 12a of the soymilk supply pipe 12, a baffle plate 30 (see FIG. 7) to be described later, a part of the coagulated product discharge pipe 14, and the like with which the soymilk, the coagulant, and the coagulated product S come into contact.

Water sprayed from the water spray device 15 is water for food production, may be clean water such as tap water or well water, and is not particularly limited to distilled water, sterile water filtered through a membrane, and the like. The sprayed water may be water of 0° C. to 100° C., preferably hot water of 40° C. to 100° C. heated by the cleaning water supply device, and more preferably hot water of 60° C. to 95° C. in terms of a bacteriostatic effect and practicality. By using the hot water, it is also possible to obtain effects of killing germs and preventing propagation of the germs, and an effect of thermally insulating a bucket.

As the sprayed water, vapor condensed water obtained by recovering water vapor with which the coagulation bucket 11 is filled may be used.

The clean water may be used for cleaning or washing, and can also be used so as to contain a quality improving agent (a food additive such as a pH adjusting agent or a puffing accelerator, or a food material). Separated water (also referred to as “a supernatant liquid” or “exuding water”) separated from a soymilk coagulated product is used as the sprayed water directly, or is used as the sprayed water after being handled hygienically by filtration, disinfection, sterilization, or the like, so that it is possible to expect a water saving effect and an effect of not cooling the soymilk coagulated product and members such as pipes and the bucket.

A pump 19 such as a metering pump or a self-priming pump that can convey the coagulated product S without crushing the coagulated product S as much as possible is provided ahead of the coagulated product discharge pipe 14, but the coagulated product S may be naturally discharged. The pump 19 is not particularly limited as long as the pump 19 is a pump having a self-priming force, such as a rotary pump, a mohno pump, a vane pump, a high viscosity liquid transfer pump, a tubing pump, or a gear pump. A discharge valve (not shown) (an automatic opening and closing valve such as a ball valve, a butterfly valve, or a gate valve) is provided in the coagulated product discharge pipe 14 so as to be openable and closable. The coagulated product discharge pipe 14 may have a downward gradient of 1% or more, and preferably 5% or more, with respect to a horizontal direction. A size of a discharge pipe is 2.0 inches or more, and is preferably 2.5 inches to 3 inches.

A member subjected to surface polishing or surface treatment processing is provided on a portion in the coagulation bucket 11 to which the coagulated product S is easily adhered. Specifically, examples of the portion to which the coagulated product is easily adhered (a portion on which the coagulated product easily remains) include the liquid contact portion, the water spray device 15, and the like, and the liquid contact portion includes the inner wall of the coagulation bucket 11, the stirring device 18 including the stirring blade 18a and the stirring shaft 18b, the baffle plate 30 to be described later, the soymilk feed port 12a, and the like. A shape of the stirring blade 18a is not limited to a general propeller type of two to four blades, and may be in a form in which an effect of crushing the coagulated product is also obtained. A stirring program such as forward rotation, reverse rotation, or multi-speed rotation may be appropriately included, and is not particularly limited.

As the surface polishing, buff mirror polishing or electrolytic polishing may be used. As the surface treatment processing, Teflon (registered trademark) coating, ceramic coating, DLC coating, sandblast processing, or water-repellent processing (a contact angle of water is 90 degrees or more) by which a fine uneven structure that achieves a lotus effect is created may be used as necessary.

The coagulation bucket 11 may include a thermal insulation unit that thermally insulates a container wall. As the thermal insulation unit, a jacketed tank including an air layer and a vacuum layer, a jacketed tank in which hot water of 40° C. to 100° C. flows through a jacket, or a thermal insulation tank in which a thermal insulation material is applied can be applied. As a result, the container wall is not cooled, adhesion of the coagulated product S can be prevented, and the homogeneous coagulated product S having high water retention property can be formed.

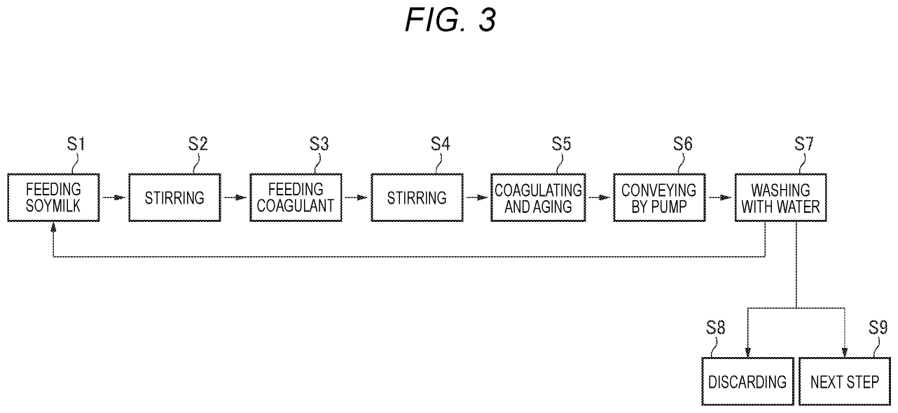

In the coagulation device 10a configured as described above, as shown in FIG. 3, the soymilk is first supplied from the soymilk plant to the coagulation bucket 11 through the soymilk supply pipe 12 (step S1), and the soymilk is stirred by the stirring device 18 immediately after the soymilk is supplied (step S2). The coagulant is supplied from the coagulant tank to the coagulation bucket 11 through the coagulant supply pipe 13 (step S3), and the soymilk and the coagulant are mixed with each other while being stirred by the stirring device 18 (step S4), thereby producing the coagulated product S (step S5). Before the soymilk is supplied or after the coagulated product is discharged, water vapor is actively supplied as necessary so as to wet an internal space.

Then, when the coagulated product S is aged for a predetermined time in the coagulation bucket 11, the discharge valve is opened and the pump 19 is activated (step S6), so that the coagulated product S is sent to a forming device for the subsequent step.

In the forming step that is the subsequent step, the coagulated product S is supplied to a storage tank of a continuous forming machine, or is directly supplied, without passing through the storage tank, to a water draining machine that separates the supernatant liquid (whey) from the coagulated product, or is directly supplied, in a total amount filling method, to a hopper of a dispenser that equally dispenses the coagulated product S onto a lower fabric, or is directly supplied onto the lower fabric of the continuous forming machine.

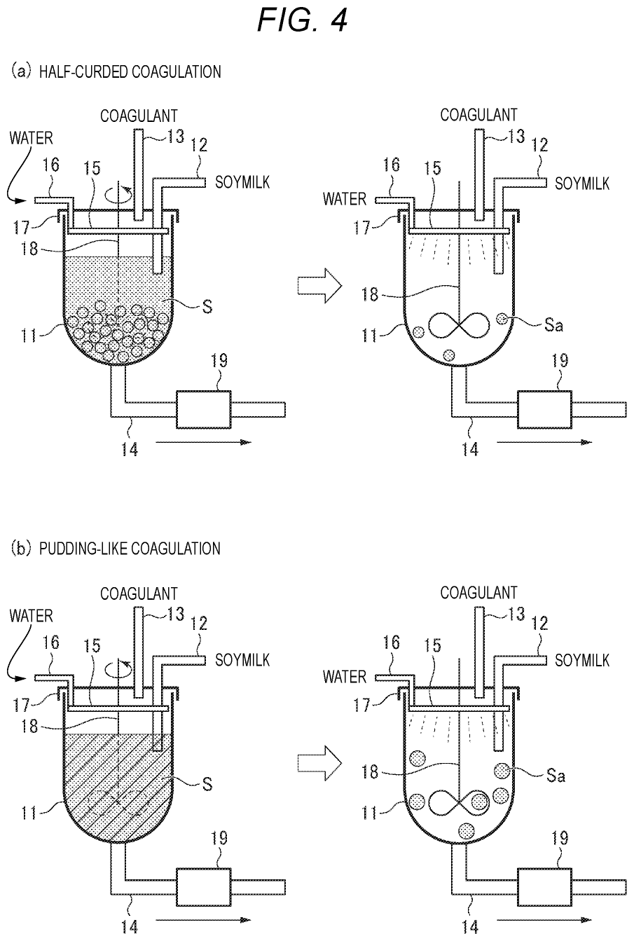

After the coagulated product S is sent to the forming device, an adhered coagulated product Sa (see FIG. 4) adhered to an inside of the coagulation bucket 11 is cleaned by the water spray device 15 (step S7).

Here, for example, when a product having a low soymilk concentration, such as deep-fried tofu, hard tofu, or dried-frozen tofu, is produced in which a concentration of the soymilk used in the coagulation device is 1 wt % to 10 wt % and is preferably 2 wt % to 7 wt %, as shown in (a) of FIG. 4, the above tofu product performs so-called “half-curded” coagulation in which a large amount of the “supernatant liquid (also referred to as isolated water or exuding water)” is produced when the coagulant (an aqueous solution or an aqueous dispersion liquid in which magnesium chloride, a bittern, calcium chloride, magnesium sulfate, calcium sulfate, or the like is mixed alone, or two or more of these components are mixed) is added and stirring and aging are performed. In this case, a separated state (so-called “precipitating soybean puree”) may be obtained in which innumerable coagulated particles having about 1 mm to 10 mm are produced in the bucket and precipitated in a lower layer and an upper layer is the “supernatant liquid”, or conversely, a separated state (so-called “floating soybean puree”) may be obtained in which innumerable coagulated particles float in an upper layer and a lower layer is an olive green liquid referred to as the “supernatant liquid” or the “exuding water”. In any case, the solution needs to be sufficiently homogenized by the stirring device 18 before discharge. In such a state of the small coagulated product S, when the cleaning water is sprayed, the adhered coagulated product Sa can flow to a next step, and the inside of the coagulation bucket 11 and an inside of the coagulated product discharge pipe 14 can be washed.

On the other hand, in a case of a product having a soymilk concentration of more than 10 wt %, as shown in (b) of FIG. 4, when the soymilk is coagulated by adding the coagulant, the “supernatant liquid” is not produced so much, and the coagulated product S (pudding-like or yogurt-like) can be produced on an entire inner surface of the coagulation bucket 11. In this state, the large adhered coagulated product Sa is strongly adhered to a side surface of the bucket, and the coagulated product cannot be flushed out with the cleaning water. However, by pulverizing the coagulated product by the stirring device 18 or the like, fluidity is improved, so that the adhered coagulated product Sa can be flushed out.

By providing the water spray device 15 in the upper portion of the coagulation bucket 11, the adhered coagulated product Sa adhered to the side surface of the coagulation bucket 11 is flushed out with water from a water spray nozzle when the coagulated product S of the soymilk and the coagulant is conveyed, so that the adhered coagulated product Sa can be conveyed and a yield rate can be improved. By flushing out with the water from the water spray nozzle, it is possible to reduce the adhered coagulated product Sa adhered to the container wall of the coagulation bucket 11, to prevent propagation of the germs (hygienic each time coagulation is performed), and to further prevent growth of the adhered coagulated product.

A coagulated product dispersion liquid containing the washed-away adhered coagulated product Sa and the sprayed water may be mixed with the coagulated product S, or may be separately discarded.

When the sprayed water and the coagulated product dispersion liquid remain in the coagulation bucket 11, the soymilk concentration is lowered in next metering of the soymilk, which impairs a taste of the tofu and leads to a decrease in quality. Therefore, it is preferable that the sprayed water and the coagulated product dispersion liquid (washing liquid) are completely discharged from the coagulation bucket 11 before next feeding of the soymilk.

The coagulation bucket 11 includes the above thermal insulation unit or is subjected to surface polishing or surface coating treatment, so that an amount of the adhered product is reduced, and it is possible to perform adjusting to reduce an amount of water during washing with water.

When washing with water is not performed periodically, the coagulated product S is gradually adhered to and further accumulated on the inner wall of the coagulation bucket 11, the stirring blade 18a, the baffle plate 30 to be described later, and the like, so that a stirring effect may change as a production time increases, sizes and a particle size distribution of particles of the coagulated product S may change, and the quality of the product may be affected. On the other hand, by periodically washing with water and preferably washing with water for each batch, and mixing a washing solution with the coagulated product S in a storage tank including a stirrer, it is possible to prevent quality of a fried product from changing due to water draining and a change in water content in the tofu.

The coagulated product S is gradually hardened over time while being adhered, and sometimes becomes a discolored mass. When the mass drops and flows to the next step, not only the tofu in which the mass is mixed is deformed and a loss is caused, but also a complaint may be made due to mixing in of a foreign matter. By washing with water, it is possible to prevent adhesion of the coagulated product S and it is also possible to prevent the coagulated product S from becoming the mass, so that such problems can be prevented from occurring.

After production is completed, in a cleaning step, water spray nozzles can spray not only water but also a chemical liquid (caustic soda or the like). Therefore, an improvement in cleaning effect of cleaning in place (CIP: a method for cleaning by pouring a cleaning agent without disassembling a device) can also be expected. In a method in the related art, a chemical liquid is only allowed to pass through a bucket, the chemical liquid is added at most in an amount larger than an amount of soymilk, and immersion cleaning is performed while rotating the stirring blade 18a. However, when the water spray nozzle is included, the upper portion of the coagulation bucket 11 can be cleaned by adjusting an amount of water and a flow rate. In particular, when CIP cleaning is performed with the chemical liquid, it is more preferable to include a lid. The chemical liquid after the cleaning is discarded to an outside (step S8).

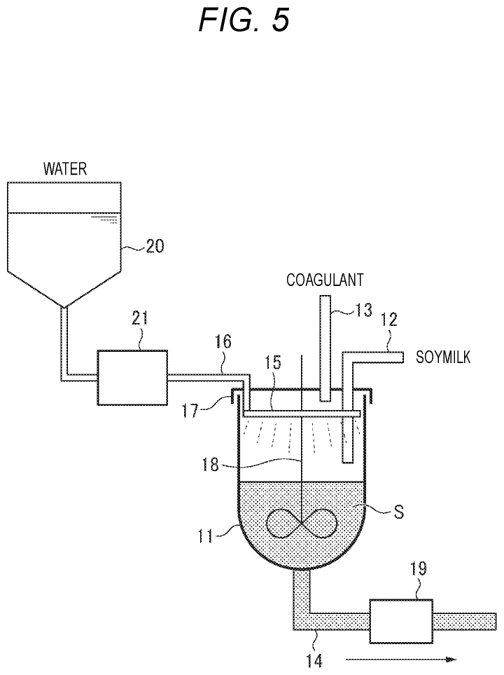

In the above embodiment, cleaning of the inside of the coagulation bucket 11 is started after the coagulated product S is conveyed to the next step, but as in first to third modifications shown in FIGS. 5 to 7, the water may be minimally sprayed at a constant flow rate from the water spray device 15 during conveyance of the coagulated product S to the next step.

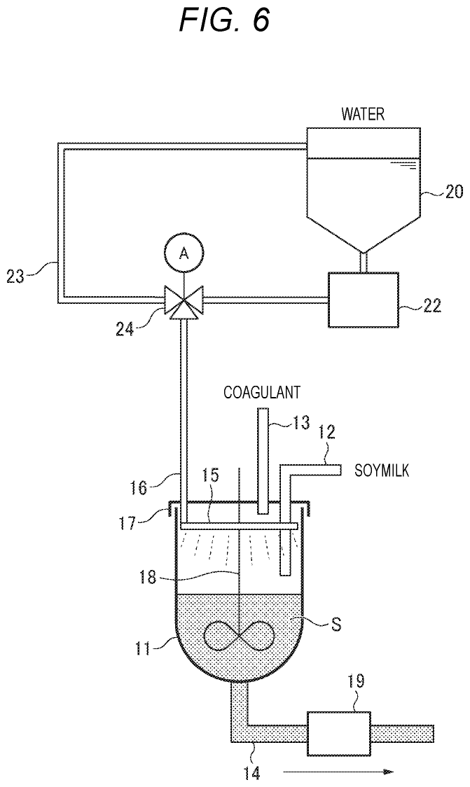

In the modification shown in FIG. 5, a constant amount of water is sent from a water tank 20 to the cleaning water supply pipe 16 by using a metering pump 21, and the constant amount of water is sprayed from the water spray device 15 into the coagulation bucket 11. In the modification shown in FIG. 6, a pump 22 is disposed in a middle, an automatic valve 24 is provided in a circulating water pipe 23, a constant amount of water metered by an opening time of the valve 24 is sent to the cleaning water supply pipe 16, and the constant amount of water is sprayed from the water spray device 15 into the coagulation bucket 11. In the modification shown in FIG. 7, the pump 22 is disposed in the middle, the automatic valve 24 is provided in the circulating water pipe 23, a constant amount of water is metered by a metering tank 25 provided with a level sensor such as an electrode sensor or a float sensor while the automatic valve 24 is opened and closed, and a valve 26 is then opened, so that the constant amount of water in the metering tank 25 is sprayed from the water spray device 15 into the coagulation bucket 11. In addition, by a method for metering a predetermined amount of water with a flowmeter or an integrating flowmeter, or the like, the water may be sprayed at a constant flow rate from the water spray device 15 during the conveyance of the coagulated product S to the next step.

An amount of the sprayed water is preferably 0.1% to 1% with respect to the soymilk in the coagulation bucket 11. As a result, the coagulated product dispersion liquid including the adhered coagulated product Sa which is washed away by the water sprayed from the water spray device 15 is conveyed to the next step through the coagulated product discharge pipe 14 (step S9).

The coagulated product dispersion liquid passing through the coagulated product discharge pipe 14 and the previously discharged coagulated product S are discharged together and uniformly mixed in a storage tank provided downstream of the pump 19. In this case, it is also possible to discharge all of the coagulated product dispersion liquid prior to the next metering of the soymilk, and it is also possible to convey the coagulated product S in the coagulation bucket 11 to the next step without unnecessarily lowering the soymilk concentration and without lowering the quality.

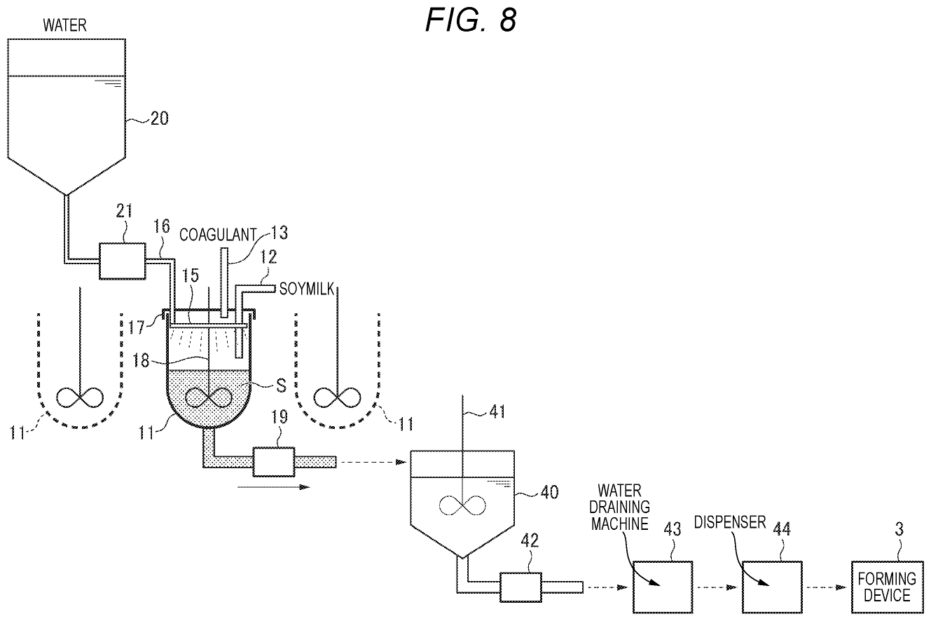

As shown in FIG. 8, the coagulated product S and the coagulated product dispersion liquid Sa from each of the plurality of coagulation buckets 11 discharged by the pump 19 may be once collected in a coagulated product collection tank (storage tank) 40 including a stirring device 41, and subsequently, by a pump 42, the coagulated product S and the coagulated product dispersion liquid Sa may be transferred to a water draining machine 43 and further sent to a forming device 3 through a dispenser 44. By collecting the coagulated product S and the coagulated product dispersion liquid Sa in the coagulated product collection tank 40, a predetermined amount of the coagulated product S and the coagulated product dispersion liquid Sa can be transferred to the water draining machine 43 rather than being directly conveyed from the coagulation bucket 11 to the water draining machine 43, and a product having a uniform thickness can be easily produced by the forming device 3 when the coagulated product S and the coagulated product dispersion liquid Sa are sent to the forming device 3 through the dispenser 44.

By spraying the cleaning water from the middle, in a case of deep-fried tofu, a part (so-called “land return”) of return water (also referred to as “added water”) added at the end of a boiling step is obtained, little fresh air is mixed, heat denaturation of a protein is prevented by slightly lowering a temperature of the coagulated product, so that a skin of the deep-fried tofu slightly becomes soft and easily stretches (easily puffs), and effects of improving the quality, improving the yield rate, and further reducing a burden of drainage can be obtained. By mixing the coagulated product with washed water obtained by washing with water, a yield is also improved by an amount that corresponds to the recovered adhered product although small.

However, when the amount of water used for washing is too much or a water temperature is lowered, there are also adverse effects that a temperature of the coagulated product S is lowered, the tofu is not well drained, and the product does not stretch. When the cleaning water is hot water, an effect of supplying air is low, but a soymilk temperature is stabilized due to a thermal insulation effect.

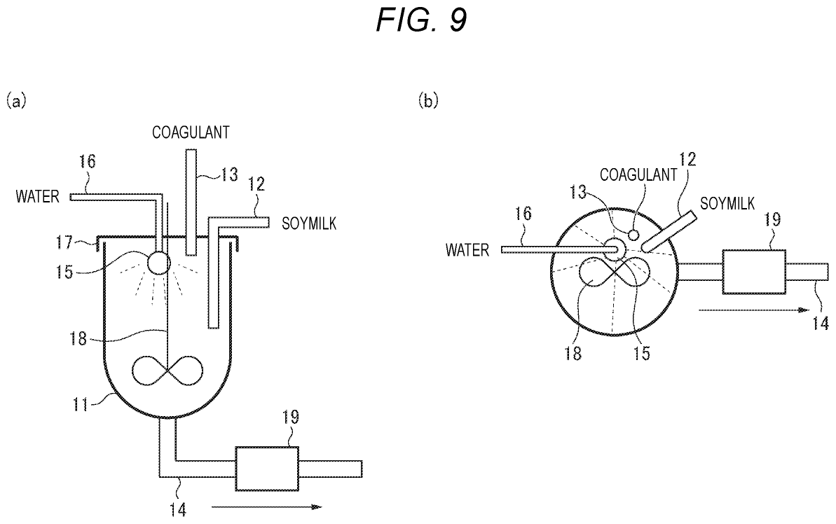

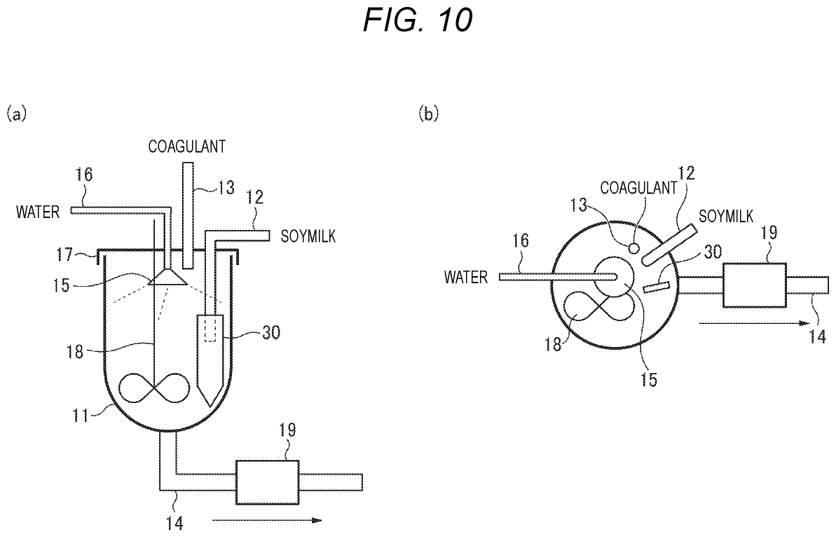

The water spray device 15 is not limited to a water spray pipe type described above, and may be a shower ball type shown in FIG. 9 or a shower nozzle type shown in FIG. 10. The water spray device 15 is not particularly limited as long as the water spray device 15 is any one of these members, or a water spray nozzle suitable for tank cleaning, such as a spray ball type, a two-dimensional or three-dimensional rotary nozzle type, or a pig tail type (nozzle that sprays water in a spiral shape).

The water spray device 15 may include a high pressure nozzle that can perform cleaning with high pressure water of 1 MPa to 10 MPa.

For example, the water spray device 15 may include a ball type or rotary type spray nozzle, may spray an alkaline or acidic cleaning chemical liquid from the nozzle to the inside of the bucket 11 during CIP cleaning, and may be used for circulation cleaning or rinsing using the chemical liquid. For finishing, water vapor, sodium hypochlorite water, hypochlorous acid water, or the like may also be sprayed from the nozzle to perform sterilization.

Further, as in a modification shown in FIG. 10, the baffle plate 30 having a quadrangular shape or the like, which changes a flow of the soymilk, is disposed in the coagulation bucket 11, and the baffle plate 30 may be fixed or may be configured such that an angle and upper and lower positions can be changed as appropriate. In the present embodiment, the adhered coagulated product Sa adhered to the baffle plate 30 can be cleaned by the cleaning water from the water spray device 15.

In the modification shown in FIG. 10, the stirring blade 18a is disposed at a position where the stirring blade 18a is eccentric from a center of the cylindrical portion 11a of the coagulation bucket 11, and a shower nozzle of the water spray device 15 is disposed at the center of the cylindrical portion 11a. Therefore, as compared with a modification shown in FIG. 9, the inside of the coagulation bucket 11 is fully filled with a cleaning liquid and is easy to be thoroughly cleaned, and the cleaning effect can be improved.

In this case, some of nozzle holes of the shower nozzle may be holes having directivity, through which the water can be sprayed toward the stirring shaft 18b, the stirring blade 18a, and the baffle plate 30.

The present invention is not limited to the above embodiments, and modifications, improvements, and the like are possible as appropriate. In addition, a material, a shape, a dimension, a numerical value, a form, the number, a disposition position, and the like of each of components in the above embodiments are not limited as long as the present invention can be achieved.

For example, the coagulation bucket 11 preferably includes the lid 17, but may not include a lid as long as a cleaning liquid from a nozzle is not scattered out from the upper portion.

In the above embodiments, the deep-fried tofu, the hard tofu, and the dried-frozen tofu are exemplified as target products, but the tofu product that is a target of the present invention may be a product obtained by breaking and forming a half-curded coagulated product or a soft pudding-like coagulated product as shown in (a) or (b) of FIG. 4, and also includes, for example, cotton tofu, deep-fried tofu, thick deep-fried tofu, tofu cutlets, dried-frozen tofu, deep-fried tofu burgers (deep-fried tofu mixed with thinly sliced vegetables), tofu products for secondary processed foods such as these frozen products, silken tofu, and tofu products obtained by pulverizing the pudding-like coagulated product. In particular, it is more preferable to use, as the target product, deep-fried tofu such as deep-fried tofu pouches, thin deep-fried tofu, or thick deep-fried tofu.

Further, in the above embodiment, a fixed bucket coagulation machine in which the plurality of coagulation buckets are fixed to the base has been described, but a round type bucket coagulation machine in which a plurality of coagulation buckets rotate around a base may be used. In a case of the round type bucket coagulation machine, a coagulated product discharge pipe may be provided, but a form in which discharging is performed by inverting the bucket is preferable.

The present application is based on Japanese Patent Application No. 2020-149764 filed on Sep. 7, 2020, the contents of which are incorporated herein by reference.

### REFERENCE SIGNS LIST

10a: coagulation device
11: coagulation bucket
12: soymilk supply pipe
13: coagulant supply pipe
14: coagulated product discharge pipe
15: water spray device
16: cleaning water supply pipe
17: lid
18: stirring device
19: pump
30: baffle plate

1. A method for producing tofu products, the method comprising:
discharging a coagulated product in which soymilk and a coagulant are mixed with each other using a coagulation device, the coagulation device comprising a coagulation bucket and a water spray device provided inside the coagulation bucket,
wherein the discharging the coagulated product comprises:
spraying water from the water spray device to wash away an adhered coagulated product in which the soymilk and the coagulant are mixed with each other and which is adhered to an inside of the coagulation bucket; and
mixing a dispersion liquid of the adhered coagulated product with the coagulated product for use.

2. The method for producing tofu products according to claim 1,
wherein the water spray device is configured to spray the water at a constant flow rate.

3. The method for producing tofu products claim 1,
wherein the water spray device is configured to spray the water during conveyance of the coagulated product, in which the soymilk and the coagulant with are mixed with each other, to a next step.

4. The method for producing tofu products according to claim 1,
wherein the water sprayed from the water spray device is water for food production, the water being hot water of 40° C. to 100° C. heated by a cleaning water supply device.

5. The method for producing tofu products according to claim 1,
wherein the coagulation bucket comprises a thermal insulation unit.

6. The method for producing tofu products according to claim 1,
wherein the inside of the coagulation bucket is formed of a member subjected to surface polishing or surface treatment processing.

7. The method for producing tofu products according to claim 1,
wherein the dispersion liquid of the adhered coagulated product is mixed with the coagulated product in a storage tank for use.

8. An apparatus for producing tofu products, the apparatus comprising:
a coagulation device comprising a coagulation bucket and a water spray device provided inside the coagulation bucket,
wherein the water spray device is configured to spray water to wash away an adhered coagulated product in which soymilk and a coagulant are mixed with each other and which is adhered to an inside of the coagulation bucket to mix a dispersion liquid of the adhered coagulated product with a coagulated product for use.

9. The apparatus for producing tofu products according to claim 8,
wherein the water spray device comprises equipment configured to spray water onto the adhered coagulated product at a constant flow rate.

10. The apparatus for producing tofu products according to claim 8,
wherein the water spray device is configured to spray the water during conveyance of the coagulated product, in which the soymilk and the coagulant are mixed with each other, to a next step.

11. The apparatus for producing tofu products according to claim 8,
wherein the water sprayed from the water spray device is water for food production, the water being hot water of 40° C. to 100° C. heated by a cleaning water supply device.

12. The apparatus for producing tofu products according to claim 8,
wherein the coagulation bucket comprises a thermal insulation unit.

13. The apparatus for producing tofu products according to claim 8,
wherein the inside of the coagulation bucket is formed of a member subjected to surface polishing or surface treatment processing.

14. The apparatus for producing tofu products according to claim 8,
wherein a storage tank configured to allow therein the dispersion liquid of the adhered coagulated product to be mixed with the coagulated product is provided in a coagulated product discharge pipe connected to the coagulation bucket.
